(19) United States
(12) Patent Application Publication
(10) Pub. No.: US 2024/0373922 A1
(43) Pub. Date: Nov. 14, 2024

(54) AEROSOL GENERATING DEVICE

(71) Applicant: KT&G CORPORATION, Daejeon (KR)

(72) Inventors: Wonkyeong LEE, Guri-si, Gyeonggi-do (KR); Paul Joon SUNWOO, Seoul (KR); Min Kyu KIM, Seoul (KR); Moon Sang LEE, Seoul (KR)

(73) Assignee: KT&G CORPORATION, Daejeon (KR)

(21) Appl. No.: 18/032,484

(22) PCT Filed: Feb. 9, 2023
(86) PCT No.: PCT/KR2023/001909

§ 371 Date: Apr. 18, 2023

(30) Foreign Application Priority Data
Feb. 11, 2022 (KR) 10-2022-0017980

(51) Int. Cl. A24F 40/46; A24F 40/20; A24F 40/51; A24F 40/65

(52) U.S. Cl. CPC A24F 40/46; A24F 40/20; A24F 40/51; A24F 40/65

(57) ABSTRACT

An aerosol generating device includes an aerosol forming substrate accommodation portion including an aerosol forming substrate and configured to generate heat by a surface plasmon resonance, and a light source configured to irradiate light toward the aerosol forming substrate accommodation portion. The light irradiated by the light source may cause the surface plasmon resonance.

### TECHNICAL FIELD

The following embodiments relate to an aerosol generating device.

### BACKGROUND ART

Recently, demands for alternative articles to overcome disadvantages of general cigarettes have increased. For example, demand for a device (e.g., a cigarette-type electronic cigarette) that generates an aerosol by electrically heating a cigarette stick are increasing. Accordingly, research on an electrically heated aerosol generating device and a cigarette stick (or an aerosol generating article) applied thereto is being actively conducted. For example, Korean Patent Publication No. 10-2017-0132823 discloses a non-combustion type flavor inhaler, a flavor inhalation component source unit, and an atomizing unit.

### DISCLOSURE OF THE INVENTION

### Technical Goals

An aspect according to an embodiment is to provide an aerosol generating device that may generate an aerosol using a surface plasmon resonance phenomenon.

An aspect according to an embodiment is to provide an aerosol generating device with an increased battery efficiency by reducing power consumed in heating by using a surface plasmon resonance phenomenon in comparison to an aerosol generating device that operates by resistive heating.

### Technical Solutions

An aerosol generating device according to various embodiments includes an aerosol forming substrate accommodation portion including an aerosol forming substrate and configured to generate heat by a surface plasmon resonance, and a light source configured to irradiate light toward the aerosol forming substrate accommodation portion. The light irradiated by the light source may be used to heat the aerosol forming substrate of the aerosol forming substrate accommodation portion by generating heat by a surface plasmon resonance.

In an embodiment, the aerosol forming substrate accommodation portion may include a plate including a plurality of recesses configured to accommodate the aerosol forming substrate.

In an embodiment, the aerosol forming substrate accommodation portion may include an anodic aluminum oxide (AAO).

In an embodiment, metal nanoparticles may be applied to a surface of the aerosol forming substrate accommodation portion.

In an embodiment, the metal nanoparticle may include at least one of gold, silver, palladium, platinum, or copper.

In an embodiment, the metal nanoparticles applied to the aerosol forming substrate accommodation portion may form a predetermined pattern on the aerosol forming substrate accommodation portion.

In an embodiment, the pattern may include a coated region to which the metal nanoparticles are applied, and an uncoated region to which the metal nanoparticles are not applied. A width of the coated region may decrease from a central portion of the coated region toward an edge portion of the coated region, and the coated region may be connected to another coated region at a junction where the coated region has a smallest width.

In an embodiment, the metal nanoparticles may be applied to have a thickness of 10 nanometers (nm) or less.

In an embodiment, the aerosol generating device may further include a reflective plate disposed to surround a space between the aerosol forming substrate accommodation portion and the light source.

In an embodiment, the light source may include at least one of a light-emitting diode (LED), a laser, a fluorescent lamp, a halogen lamp, or an incandescent lamp.

In an embodiment, the plate may be replaceable.

In an embodiment, the plate may be disposed between the light source and a mouthpiece of the aerosol generating device.

In an embodiment, the light source may be disposed between the plate and a mouthpiece of the aerosol generating device.

In an embodiment, the light source may include at least one hole through which the aerosol generated in the plate reaches the mouthpiece.

In an embodiment, the aerosol generating device may further include a rotation plate, and a plurality of plates disposed on the rotation plate. The plurality of plates may be disposed to surround a central axis of the rotation plate.

In an embodiment, the light source may be configured to irradiate light to at least one of the plurality of plates disposed on the rotation plate.

In an embodiment, the aerosol generating device may further include a housing including a first end surface, a second end surface opposite to the first end surface, and an inner side surface connecting the first end surface and the second end surface. The light source may be disposed on the inner side surface of the housing and configured to irradiate light toward an inside of the housing, and the plate may be disposed to face the light source.

### Effects

According to an embodiment, an aerosol generating device and an aerosol generating system may generate an aerosol using a surface plasmon resonance phenomenon.

According to an embodiment, an aerosol generating device and an aerosol generating system may have an increased battery efficiency by reducing power consumed in heating by using a surface plasmon resonance phenomenon in comparison to power consumed in an aerosol generating device that operates by resistive heating.

The effects of the aerosol generating device and the aerosol generating system according to an embodiment are not limited to the above-mentioned effects, and other unmentioned effects can be clearly understood from the following description by one of ordinary skill in the art.

### BRIEF DESCRIPTION OF DRAWINGS

FIGS. 1 to 3 are diagrams illustrating examples of a cigarette inserted into an aerosol generating device according to an embodiment.

FIGS. 4 and 5 are diagrams of examples of a cigarette according to an embodiment.

FIG. 6 is a block diagram of an aerosol generating device according to an embodiment.

FIG. 7a is a cross-sectional view of an example of an aerosol generating device according to an embodiment.

FIG. 7b is a cross-sectional view of an aerosol forming substrate accommodation portion according to an embodiment.

FIGS. 7c and 7d are diagrams illustrating examples of a pattern in which metal nanoparticles are applied to an aerosol forming substrate accommodation portion according to an embodiment.

FIG. 8a is a cross-sectional view of another example of an aerosol generating device according to an embodiment.

FIG. 8b is a diagram illustrating a shape of a light source according to an embodiment.

FIG. 9 is a diagram illustrating a rotation plate according to an embodiment.

FIG. 10 is a cross-sectional view of another example of an aerosol generating device according to an embodiment.

### BEST MODE FOR CARRYING OUT THE INVENTION

The terms used in the embodiments are selected from among common terms that are currently widely used, in consideration of their function in the disclosure. However, the terms may become different according to an intention of one of ordinary skill in the art, a precedent, or the advent of new technology. Also, in particular cases, the terms are discretionally selected by the applicant of the disclosure, and the meaning of those terms will be described in detail in the corresponding part of the detailed description. Therefore, the terms used in the disclosure are not merely designations of the terms, but the terms are defined based on the meaning of the terms and content throughout the disclosure.

It will be understood that when a certain part “includes” a certain component, the part does not exclude another component but may further include another component, unless the context clearly dictates otherwise. Also, terms such as “unit,” “module,” etc., as used in the specification may refer to a part for processing at least one function or operation and may be implemented as hardware, software, or a combination of hardware and software.

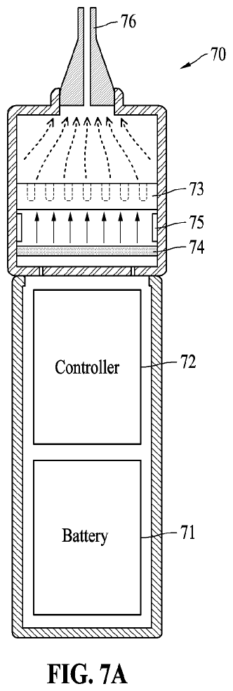

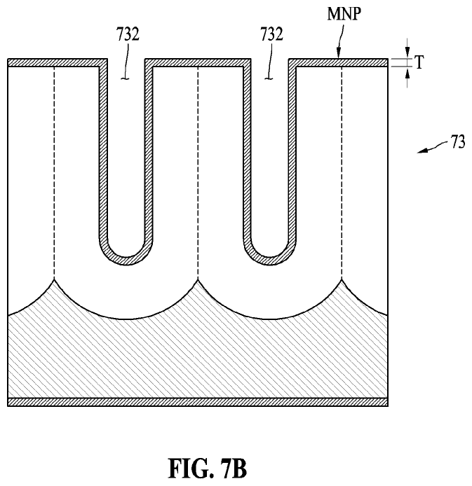

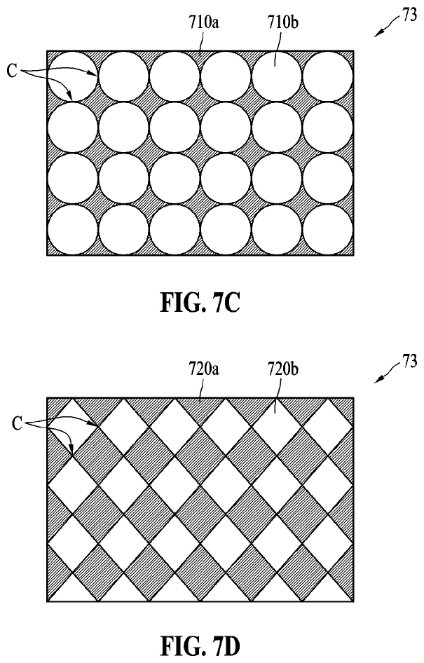

In the following embodiments, the term “upstream” or “upstream direction” may refer to a direction away from an oral region of a user (smoker), and the term “downstream” or “downstream direction” may refer to a direction approaching the oral region of the user. The terms “upstream” and “downstream” may be used to describe relative positions of components of an aerosol generating article. For example, in an aerosol generating device 70 illustrated in FIG. 7a, a light source 74 may be disposed upstream or in an upstream direction of an aerosol forming substrate accommodation portion 73, and the aerosol forming substrate accommodation portion 73 may be disposed downstream or in a downstream direction of the light source 74.

In the following embodiments, the term “puff” refers to inhalation by a user, and the inhalation refers to a situation in which a user draws in an aerosol into his or her oral cavity, nasal cavity, or lungs through the mouth or nose. In the following embodiments, “surface plasmon resonance” refers to resonance of polarized light of charges on a surface of metal nanoparticles by an oscillation of free electrons of the metal nanoparticles. The polarization of charges according to resonance of free electrons may be stimulated by light incident onto the metal nanoparticles from a light source, and energy from oscillating free electrons may be dissipated in the form of thermal energy by various mechanisms. Through the above process, when metal nanoparticles are irradiated with a light source, the metal nanoparticles may generate heat by surface plasmon resonance.

In the following embodiments, a “metal nanoparticle” refers to a metal particle having a diameter of 1 nanometers (nm) to 1000 nm. Metal nanoparticles may generate heat by surface plasmon resonance when excited by light emitted from a light source. Metal nanoparticles according to an embodiment may also be referred to as “plasmonic nanoparticles.”

Hereinbelow, embodiments of the present disclosure will be described in detail with reference to the accompanying drawings so that the embodiments may be readily implemented by one of ordinary skill in the art to which the present disclosure pertains. However, the present disclosure may be implemented in many different forms and is not limited to the embodiments described herein.

Hereinafter, embodiments of the disclosure will be described in detail with reference to the drawings.

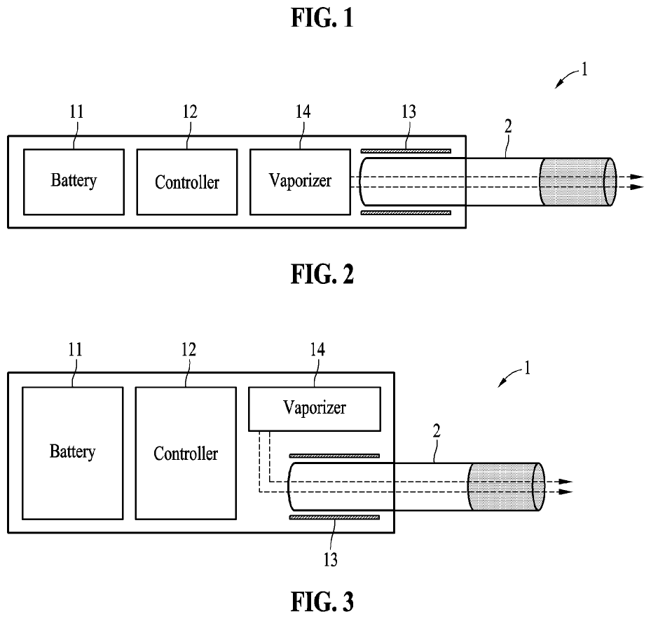

FIGS. 1 to 3 are diagrams illustrating examples of a cigarette being inserted into an aerosol generating device.

Referring to FIG. 1, an aerosol generating device 1 may include a battery 11, a controller 12, and a heater 13. Referring to FIGS. 2 and 3, the aerosol generating device 1 may further include a vaporizer 14. A cigarette 2 may be inserted into an inner space of the aerosol generating device 1.

The aerosol generating device 1 shown in FIGS. 1 to 3 may include components related to an embodiment described herein. Therefore, it is to be understood by one of ordinary skill in the art to which the present disclosure pertains that the aerosol generating device 1 may further include other general-purpose components in addition to the components shown in FIGS. 1 to 3.

In addition, although it is shown that the heater 13 is included in the aerosol generating device 1 in FIGS. 2 and 3, the heater 13 may be omitted as needed.

FIG. 1 illustrates a linear alignment of the battery 11, the controller 12, and the heater 13. FIG. 2 illustrates a linear alignment of the battery 11, the controller 12, the vaporizer 14, and the heater 13. FIG. 3 illustrates a parallel alignment of the vaporizer 14 and the heater 13. However, the internal structure of the aerosol generating device 1 is not limited to what is shown in FIGS. 1 to 3. That is, the alignments of the battery 11, the controller 12, the heater 13, and the vaporizer 14 may be changed depending on the design of the aerosol generating device 1.

When the cigarette 2 is inserted into the aerosol generating device 1, the aerosol generating device 1 may operate the heater 13 and/or the vaporizer 14 to generate an aerosol. The aerosol generated by the heater 13 and/or the vaporizer 14 may pass through the cigarette 2 into a user.

Even when the cigarette 2 is not inserted in the aerosol generating device 1, the aerosol generating device 1 may heat the heater 13, as needed.

The battery 11 may supply power to be used to operate the aerosol generating device 1. For example, the battery 11 may supply power to heat the heater 13 or the vaporizer 14, and may supply power required for the controller 12 to operate. In addition, the battery 11 may supply power required to operate a display, a sensor, a motor, or the like installed in the aerosol generating device 1.

The controller 12 may control the overall operation of the aerosol generating device 1. Specifically, the controller 12 may control respective operations of other components included in the aerosol generating device 1, in addition to the battery 11, the heater 13, and the vaporizer 14. In addition, the controller 12 may verify a state of each of the components of the aerosol generating device 1 to determine whether the aerosol generating device 1 is in an operable state.

The controller 12 may include at least one processor. The processor may be implemented as an array of a plurality of logic gates, or may be implemented as a combination of a general-purpose microprocessor and a memory in which a program executable by the microprocessor is stored. In addition, it is to be understood by one of ordinary skill in the art to which the present disclosure pertains that the processor may be implemented in other types of hardware.

The heater 13 may be heated by power supplied by the battery 11. For example, when a cigarette is inserted in the aerosol generating device 1, the heater 13 may be disposed outside the cigarette. The heated heater 13 may thus raise a temperature of an aerosol generating material in the cigarette.

The heater 13 may be an electrically resistive heater. For example, the heater 13 may include an electrically conductive track, and the heater 13 may be heated as a current flows through the electrically conductive track. However, the heater 13 is not limited to the foregoing example, and any example of heating the heater 13 up to a desired temperature may be applicable without limitation. Here, the desired temperature may be preset in the aerosol generating device 1 or may be set by the user.

In another example, the heater 13 may be an induction heater. Specifically, the heater 13 may include an electrically conductive coil for heating a cigarette in an induction heating manner, and the cigarette may include a susceptor to be heated by the induction heater.

For example, the heater 13 may include a tubular heat transfer element, a plate-shaped heat transfer element, a needle-shaped heat transfer element, or a rod-shaped heat transfer element, and may heat the inside or outside of the cigarette 2 according to the shape of a heat transfer element.

In addition, the heater 13 may be provided as a plurality of heaters in the aerosol generating device 1. In this case, the plurality of heaters 13 may be disposed to be inserted into the cigarette 2, or may be disposed outside the cigarette 2. In addition, some of the heaters 13 may be disposed to be inserted into the cigarette 2, and the rest may be disposed outside the cigarette 2. However, the shape of the heater 13 is not limited to what is shown in FIGS. 1 to 3 but may be provided in various shapes.

The vaporizer 14 may heat a liquid composition to generate an aerosol, and the generated aerosol may pass through the cigarette 2 into the user. That is, the aerosol generated by the vaporizer 14 may travel along an airflow path of the aerosol generating device 1, and the airflow path may be configured such that the aerosol generated by the vaporizer 14 may pass through the cigarette 2 into the user.

For example, the vaporizer 14 may include a liquid storage, a liquid transfer means, and a heat transfer element. However, embodiments are not limited thereto. For example, the liquid storage, the liquid transfer means, and the heat transfer element may be included as independent modules in the aerosol generating device 1.

The liquid storage may store the liquid composition. The liquid composition may be, for example, a liquid including a tobacco-containing material that includes a volatile tobacco flavor component, or may be a liquid including a non-tobacco material. The liquid storage may be manufactured to be detachable and attachable from and to the vaporizer 14, or may be manufactured in an integral form with the vaporizer 14.

The liquid composition may include, for example, water, a solvent, ethanol, a plant extract, a fragrance, a flavoring agent, or a vitamin mixture. The fragrance may include, for example, menthol, peppermint, spearmint oil, various fruit flavor ingredients, and the like. However, embodiments are not limited thereto. The flavoring agent may include ingredients that provide a user with a variety of flavors or scents. The vitamin mixture may be a mixture of at least one of vitamin A, vitamin B, vitamin C, or vitamin E, but is not limited thereto. The liquid composition may also include an aerosol former such as glycerin and propylene glycol.

The liquid transfer means may transfer the liquid composition in the liquid storage to the heat transfer element. The liquid transfer means may be, for example, a wick such as cotton fiber, ceramic fiber, glass fiber, or porous ceramic, but is not limited thereto.

The heat transfer element may be an element configured to heat the liquid composition transferred by the liquid transfer means. The heat transfer element may be, for example, a metal heating wire, a metal heating plate, a ceramic heater, or the like, but is not limited thereto. In addition, the heat transfer element may include a conductive filament such as a nichrome wire, and may be arranged in a structure wound around the liquid transfer means. The heat transfer element may be heated as a current is supplied and may transfer heat to the liquid composition in contact with the heat transfer element, and may thereby heat the liquid composition. As a result, an aerosol may be generated.

For example, the vaporizer 14 may also be referred to as a cartomizer or an atomizer, but is not limited thereto.

The aerosol generating device 1 may further include general-purpose components in addition to the battery 11, the controller 12, the heater 13, and the vaporizer 14. For example, the aerosol generating device 1 may include a display that outputs visual information and/or a motor that outputs tactile information. In addition, the aerosol generating device 1 may include at least one sensor (e.g., a puff sensor, a temperature sensor, a cigarette insertion detection sensor, etc.). In addition, the aerosol generating device 1 may be manufactured to have a structure in which external air may be introduced or internal gas may flow out even with the cigarette 2 being inserted.

Although not shown in FIGS. 1 to 3, the aerosol generating device 1 may constitute a system along with a separate cradle. For example, the cradle may be used to charge the battery 11 of the aerosol generating device 1. Alternatively, the cradle may be used to heat the heater 13, with the cradle and the aerosol generating device 1 coupled.

The cigarette 2 may be of a similar type to a general burning type. For example, the cigarette 2 may be divided into a first portion including an aerosol generating material, and a second portion including a filter or the like. Alternatively, the second portion of the cigarette 2 may also include the aerosol generating material. For example, the aerosol generating material provided in the form of granules or capsules may be inserted into the second portion.

The first portion may be entirely inserted into the aerosol generating device 1, and the second portion may be exposed outside. Alternatively, only the first portion may be partially inserted into the aerosol generating device 1, or the first portion may be entirely into the aerosol generating device 1 and the second portion may be partially inserted into the aerosol generating device 1. The user may inhale the aerosol with the second portion in their mouth. In this case, the aerosol may be generated as external air passes through the first portion, and the generated aerosol may pass through the second portion into the mouth of the user.

For example, the external air may be introduced through at least one air path formed in the aerosol generating device 1. In this example, opening or closing and/or the size of the air path formed in the aerosol generating device 1 may be adjusted by the user. Accordingly, an amount of atomization, a sense of smoking, or the like may be adjusted by the user. In another example, the external air may be introduced into the inside of the cigarette 2 through at least one hole formed on a surface of the cigarette 2.

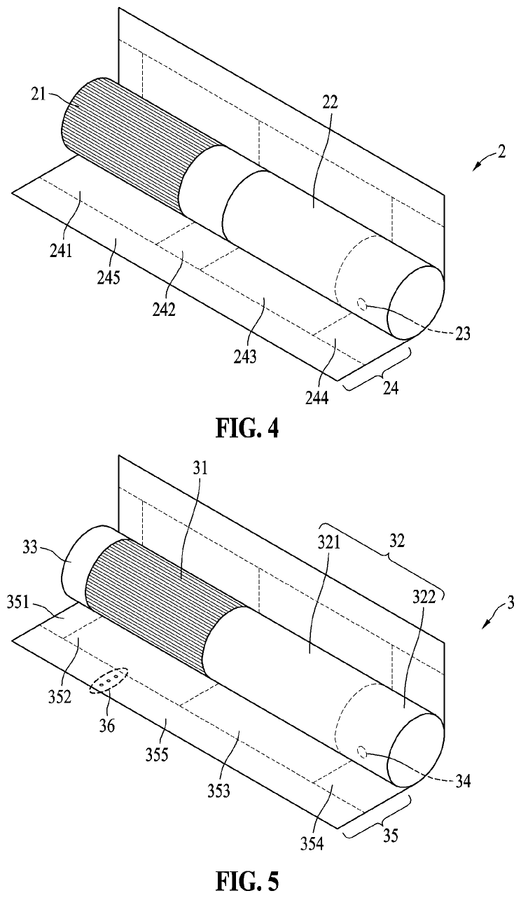

Hereinafter, examples of the cigarette 2 will be described with reference to FIGS. 4 and 5.

FIGS. 4 and 5 are perspective views of examples of a cigarette according to an embodiment.

Referring to FIG. 4, the cigarette 2 may include a tobacco rod 21 and a filter rod 22. The first portion and the second portion described above with reference to FIGS. 1 to 3 may include the tobacco rod 21 and the filter rod 22, respectively.

Although the filter rod 22 is illustrated as having a single segment in FIG. 4, examples of which are not limited thereto. That is, the filter rod 22 may include a plurality of segments. For example, the filter rod 22 may include a segment that cools an aerosol and a segment that filters a predetermined ingredient contained in an aerosol. In addition, the filter rod 22 may further include at least one segment that performs another function, as needed.

The cigarette 2 may have a diameter of about 5 millimeters (mm) to about 9 mm, and a length of about 48 mm. However, embodiments are not limited thereto. For example, a length of the tobacco rod 21 may be about 12 mm, a length of a first segment of the filter rod 22 may be about 10 mm, a length of a second segment of the filter rod 22 may be about 14 mm, and a length of a third segment of the filter rod 22 may be about 12 mm. However, embodiments are not limited thereto.

The cigarette 2 may be wrapped with at least one wrapper 24. The wrapper 24 may have at least one hole through which external air is introduced or internal gas flows out. In an example, the cigarette 2 may be wrapped with one wrapper 24. In another example, the cigarette 2 may be wrapped with two or more wrappers 24 in an overlapping manner. For example, the tobacco rod 21 may be wrapped with a first wrapper 241, and the filter rod 22 may be wrapped with wrappers 242, 243, and 244. In addition, the cigarette 2 may be entirely wrapped again with a single wrapper, for example, a fifth wrapper 245. For example, when the filter rod 22 includes a plurality of segments, the plurality of segments may be wrapped with the wrappers 242, 243, and 244, respectively.

The first wrapper 241 and the second wrapper 242 may be formed of general filter wrapping paper. For example, the first wrapper 241 and the second wrapper 242 may be porous wrapping paper or non-porous wrapping paper. In addition, the first wrapper 241 and the second wrapper 242 may be formed of oilproof paper and/or an aluminum laminated wrapping material.

The third wrapper 243 may be formed of hard wrapping paper. For example, a basis weight of the third wrapper 243 may be in a range of 88 grams per square meter (g/m²) to 96 g/m², and may desirably be in a range of 90 g/m² to 94 g/m². In addition, a thickness of the third wrapper 243 may be in a range of 120 micrometers (μm) to 130 μm, and desirably, may be 125 μm.

The fourth wrapper 244 may be formed of oilproof hard wrapping paper. For example, a basis weight of the fourth wrapper 244 may be in a range of 88 g/m² to 96 g/m², and may desirably be in a range of 90 g/m² to 94 g/m². In addition, a thickness of the fourth wrapper 244 may be in a range of 120 μm to 130 μm, and desirably, may be 125 μm.

The fifth wrapper 245 may be formed of sterile paper (e.g., MFW). Here, the sterilized paper (MFW) may refer to paper specially prepared to enhance tensile strength, water resistance, smoothness, or the like, compared to general paper. For example, a basis weight of the fifth wrapper 245 may be in a range of about 57 g/m² to about 63 g/m², and may desirably be about 60 g/m². In addition, a thickness of the fifth wrapper 245 may be in a range of 64 μm to 70 μm, and desirably, may be 67 μm.

The fifth wrapper 245 may have a predetermined material internally added thereto. The predetermined material may be, for example, silicon. However, embodiments are not limited thereto. Silicon may have properties, such as, for example, heat resistance with less change by temperature, oxidation resistance which refers to resistance to oxidation, resistance to various chemicals, water repellency against water, or electrical insulation. However, silicon may not necessarily be used, and any material having such properties described above may be applied to (or used to coat) the fifth wrapper 245 without limitation.

The fifth wrapper 245 may prevent the cigarette 2 from burning. For example, there may be a probability that the cigarette 2 burns when the tobacco rod 21 is heated by the heater 13. For example, when the temperature rises above an ignition point of any one of materials included in the tobacco rod 21, the cigarette 2 may burn. In this case, it may be possible to prevent the cigarette 2 from burning because the fifth wrapper 245 includes a non-combustible material.

In addition, the fifth wrapper 245 may prevent a holder from being contaminated by substances produced in the cigarette 2. For example, liquid substances may be produced in the cigarette 2 when a user puffs. For example, as an aerosol generated in the cigarette 2 is cooled by external air, such liquid substances (e.g., water, etc.) may be produced. Thus, wrapping the cigarette 2 with the fifth wrapper 245 may prevent the liquid substances produced in the cigarette 2 from leaking out of the cigarette 2.

The tobacco rod 21 may include an aerosol generating material. The aerosol generating material may include, for example, at least one of glycerin, propylene glycol, ethylene glycol, dipropylene glycol, diethylene glycol, triethylene glycol, tetraethylene glycol, or oleyl alcohol, but is not limited thereto. The tobacco rod 21 may also include other additives, for example, a flavoring agent, a wetting agent, and/or an organic acid. In addition, the tobacco rod 21 may include a flavoring liquid such as menthol or a moisturizer that is added as being sprayed onto the tobacco rod 21.

The tobacco rod 21 may be manufactured in various forms. For example, the tobacco rod 21 may be manufactured as a sheet or as a strand. Alternatively, the tobacco rod 21 may be formed of tobacco leaves finely cut from a tobacco sheet. In addition, the tobacco rod 21 may be enveloped by a thermally conductive material. The thermally conductive material may be, for example, a metal foil such as an aluminum foil, but is not limited thereto. For example, the thermally conductive material enveloping the tobacco rod 21 may evenly distribute the heat transferred to the tobacco rod 21 to improve the conductivity of the heat to be applied to the tobacco rod 21, thereby improving the taste of tobacco. In addition, the thermally conductive material enveloping the tobacco rod 21 may function as a susceptor heated by an induction heater. Here, although not shown in the drawings, the tobacco rod 21 may further include an additional susceptor in addition to the thermally conductive material enveloping the outside thereof.

The filter rod 22 may be a cellulose acetate filter. However, a shape of the filter rod 22 is not limited. For example, the filter rod 22 may be a cylindrical rod, or a tubular rod including a hollow therein. The filter rod 22 may also be a recess-type rod. For example, when the filter rod 22 includes a plurality of segments, at least one of the segments may be manufactured in a different shape.

A first segment of the filter rod 22 may be a cellulose acetate filter. For example, the first segment may be a tubular structure including a hollow therein. In this example, using the first segment, internal materials of the tobacco rod 21 may be prevented from being pushed back when the heater 13 is inserted, and an aerosol cooling effect may be generated. A desirable diameter of the hollow included in the first segment may be adopted from a range of 2 mm to 4.5 mm, however, embodiments are not limited thereto.

A desirable length of the first segment may be adopted from a range of about 4 mm to about 30 mm, however, embodiments are not limited thereto. The length of the first segment may desirably be 10 mm, but is not limited thereto.

The first segment may have a hardness that may be adjusted by adjusting content of a plasticizer in a process of manufacturing the first segment. In addition, the first segment may be manufactured by inserting a structure such as a film or a tube of the same or different materials therein (e.g., in the hollow).

A second segment of the filter rod 22 may cool an aerosol generated as the heater 13 heats the tobacco rod 21. The user may thus inhale the aerosol cooled down to a suitable temperature.

A length or diameter of the second segment may be determined in various ways according to the shape of the cigarette 2. For example, a desirable length of the second segment may be adopted from a range of 7 mm to 20 mm. Desirably, the length of the second segment may be about 14 mm, however, embodiments are not limited thereto.

The second segment may be manufactured by weaving a polymer fiber. In this case, a flavoring liquid may be applied to a fiber formed of a polymer. Alternatively, the second segment may be manufactured by weaving a separate fiber to which a flavoring liquid is applied and the fiber formed of the polymer together. Alternatively, the second segment may be formed with a crimped polymer sheet.

For example, the polymer may be prepared with a material selected from a group consisting of polyethylene (PE), polypropylene (PP), polyvinyl chloride (PVC), polyethylene terephthalate (PET), polylactic acid (PLA), cellulose acetate (CA,) and aluminum foil.

As the second segment is formed with the woven polymer fiber or the crimped polymer sheet, the second segment may include a single channel or a plurality of channels extending in a longitudinal direction. A channel used herein may refer to a path through which gas (e.g., air or aerosol) passes.

For example, the second segment formed with the crimped polymer sheet may be formed of a material having a thickness between about 5 μm and about 300 μm, for example, between about 10 μm and about 250 μm. In addition, a total surface area of the second segment may be in a range of about 300 mm²/mm to about 1000 mm²/mm. Further, an aerosol cooling element may be formed from a material having a specific surface area between about 10 mm²/mg and about 100 mm²/mg.

The second segment may include a thread containing a volatile flavor ingredient. The volatile flavor ingredient may be menthol, but is not limited thereto. For example, the thread may be filled with a sufficient amount of menthol to provide at least 1.5 milligrams (mg) of menthol to the second segment.

A third segment of the filter rod 22 may be a cellulose acetate filter. A desirable length of the third segment may be adopted from a range of 4 mm to 20 mm. For example, the length of the third segment may be about 12 mm, however, embodiments are not limited thereto.

The third segment may be manufactured such that a flavor is generated by spraying a flavoring liquid onto the third segment in the process of manufacturing the third segment. Alternatively, a separate fiber to which the flavoring liquid is applied may be inserted into the third segment. An aerosol generated in the tobacco rod 21 may be cooled as it passes through the second segment of the filter rod 22, and the cooled aerosol may pass through the third segment into a user. Accordingly, when a flavoring element is added to the third segment, the flavor carried to the user may last much longer.

In addition, the filter rod 22 may include at least one capsule 23. Here, the capsule 23 may perform a function of generating a flavor or a function of generating an aerosol. For example, the capsule 23 may have a structure in which a liquid containing a fragrance is wrapped with a film. The capsule 23 may have a spherical or cylindrical shape, but is not limited thereto.

Referring to FIG. 5, a cigarette 3 may further include a front end plug 33. The front end plug 33 may be disposed on one side of a tobacco rod 31 opposite to a filter rod 32. The front end plug 33 may prevent the tobacco rod 31 from escaping to the outside, and may also prevent an aerosol liquefied in the tobacco rod 31 during smoking from flowing into an aerosol generating device (e.g., the aerosol generating device 1 of FIGS. 1 to 3).

The filter rod 32 may include a first segment 321 and a second segment 322. Here, the first segment 321 may correspond to the first segment of the filter rod 22 of FIG. 4, and the second segment 322 may correspond to the third segment of the filter rod 22 of FIG. 4.

A diameter and a total length of the cigarette 3 may correspond to the diameter and the total length of the cigarette 2 of FIG. 4. For example, a length of the front end plug 33 may be about 7 mm, a length of the tobacco rod 31 may be about 15 mm, a length of the first segment 321 may be about 12 mm, and a length of the second segment 322 may be about 14 mm. However, embodiments are not limited thereto.

The cigarette 3 may be wrapped with at least one wrapper 35. The wrapper 35 may have at least one hole through which external air is introduced or internal gas flows out. For example, the front end plug 33 may be wrapped with a first wrapper 351, the tobacco rod 31 may be wrapped with a second wrapper 352, the first segment 321 may be wrapped with a third wrapper 353, and the second segment 322 may be wrapped with a fourth wrapper 354. In addition, the cigarette 3 may be entirely wrapped again with a fifth wrapper 355.

In addition, at least one perforation 36 may be formed in the fifth wrapper 355. For example, the perforation 36 may be formed in an area surrounding the tobacco rod 31. However, embodiments are not limited thereto. The perforation 36 may perform a function of transferring heat generated by the heater 13 shown in FIGS. 2 and 3 to the inside of the tobacco rod 31.

In addition, the second segment 322 may include at least one capsule 34. The capsule 34 may perform a function of generating a flavor or a function of generating an aerosol. For example, the capsule 34 may have a structure in which a liquid containing a fragrance is wrapped with a film. The capsule 34 may have a spherical or cylindrical shape, but is not limited thereto.

The first wrapper 351 may be a combination of general filter wrapping paper and a metal foil such as aluminum foil. For example, a total thickness of the first wrapper 351 may be in a range of 45 μm to 55 μm, and may desirably be about 50.3 μm. In addition, a thickness of the metal foil of the first wrapper 351 may be in a range of 6 μm to 7 μm, and may desirably be about 6.3 μm. In addition, a basis weight of the first wrapper 351 may be in a range of 50 g/m² to 55 g/m², and may desirably be about 53 g/m².

The second wrapper 352 and the third wrapper 353 may be formed with general filter wrapping paper. For example, the second wrapper 352 and the third wrapper 353 may be porous wrapping paper or non-porous wrapping paper.

For example, the porosity of the second wrapper 352 may be about 35000 CU. However, embodiments are not limited thereto. In addition, a thickness of the second wrapper 352 may be in a range of 70 μm to 80 μm, and may desirably be about 78 μm. In addition, a basis weight of the second wrapper 352 may be in a range of 20 g/m² to 25 g/m², and may desirably be about 23.5 g/m².

For example, the porosity of the third wrapper 353 may be about 24000 CU. However, embodiments are not limited thereto. In addition, a thickness of the third wrapper 353 may be in a range of 60 μm to 70 μm, and may desirably be about 68 μm. In addition, a basis weight of the third wrapper 353 may be in a range of 20 g/m² to 25 g/m², and may desirably be about 21 g/m².

The fourth wrapper 354 may be formed with polylactic acid (PLA) laminated paper. Here, the PLA laminated paper may refer to three-ply paper including a paper layer, a PLA layer, and a paper layer. For example, a thickness of the fourth wrapper 354 may be in a range of 100 μm to 120 μm, and may desirably be about 110 μm. In addition, a basis weight of the fourth wrapper 354 may be in a range of 80 g/m² to 100 g/m², and may desirably be about 88 g/m².

The fifth wrapper 355 may be formed of sterile paper (e.g., MFW). Here, the sterilized paper (MFW) may refer to paper specially prepared to enhance tensile strength, water resistance, smoothness, or the like, compared to general paper. For example, a basis weight of the fifth wrapper 355 may be in a range of about 57 g/m² to about 63 g/m², and may desirably be about 60 g/m². In addition, a thickness of the fifth wrapper 355 may be in a range of 64 μm to 70 μm, and may desirably be about 67 μm.

The fifth wrapper 355 may have a predetermined material internally added thereto. The predetermined material may be, for example, silicon. However, embodiments are not limited thereto. Silicon may have properties, such as, for example, heat resistance with less change by temperature, oxidation resistance which refers to resistance to oxidation, resistance to various chemicals, water repellency against water, or electrical insulation. However, silicon may not necessarily be used, and any material having such properties described above may be applied to (or used to coat) the fifth wrapper 355 without limitation.

The front end plug 33 may be formed of cellulose acetate. For example, the front end plug 33 may be manufactured by adding a plasticizer (e.g., triacetin) to cellulose acetate tow. A mono denier of a filament constituting the cellulose acetate tow may be in a range of 1.0 to 10.0, and may desirably be in a range of 4.0 to 6.0. A mono denier of the filament of the front end plug 33 may be more desirably about 5.0. In addition, a cross section of the filament of the front end plug 33 may be Y-shaped. A total denier of the front end plug 33 may be in a range of 20000 to 30000, and may desirably be in a range of 25000 to 30000. The total denier of the front end plug 33 may be more desirably 28000.

In addition, as needed, the front end plug 33 may include at least one channel, and a cross-sectional shape of the channel may be provided in various ways.

The tobacco rod 31 may correspond to the tobacco rod 21 described above with reference to FIG. 4. Thus, a detailed description of the tobacco rod 31 will be omitted herein.

The first segment 321 may be formed of cellulose acetate. For example, the first segment may be a tubular structure including a hollow therein. The first segment 321 may be manufactured by adding a plasticizer (e.g., triacetin) to cellulose acetate tow. For example, a mono denier and a total denier of the first segment 321 may be the same as the mono denier and the total denier of the front end plug 33.

The second segment 322 may be formed of cellulose acetate. A mono denier of a filament of the second segment 322 may be in a range of 1.0 to 10.0, and may desirably be in a range of 8.0 to 10.0. The mono denier of the filament of the second segment 322 may be more desirably 9.0. In addition, a cross section of the filament of the second segment 322 may be Y-shaped. A total denier of the second segment 322 may be in a range of about 20000 to about 30000, and may desirably be about 25000.

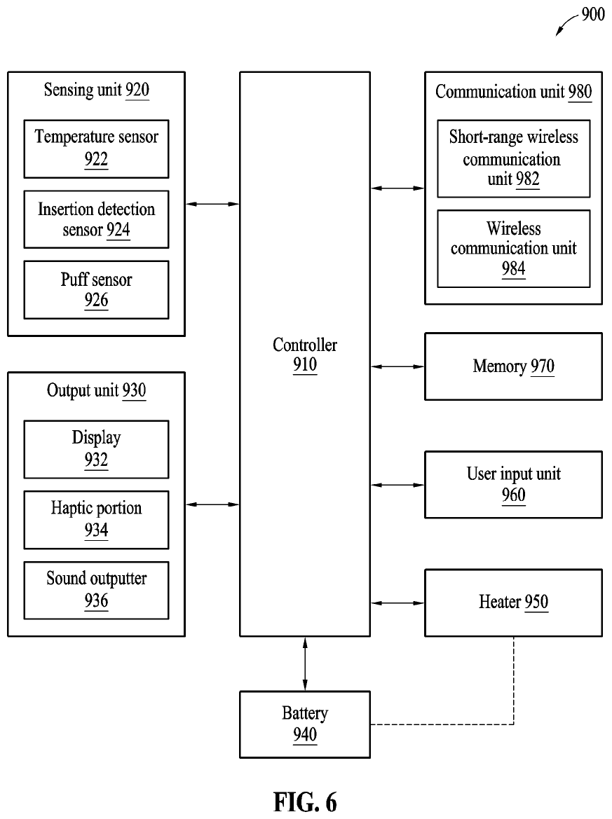

FIG. 6 is a block diagram illustrating an aerosol generating device 900 according to an embodiment.

The aerosol generating device 900 may include a controller 910, a sensing unit 920, an output unit 930, a battery 940, a heater 950, a user input unit 960, a memory 970, and a communication unit 980. However, the internal structure of the aerosol generating device 900 is not limited to what is shown in FIG. 6. It is to be understood by one of ordinary skill in the art to which the present disclosure pertains that some of the components shown in FIG. 6 may be omitted or new components may be added according to the design of the aerosol generating device 900.

The sensing unit 920 may sense a state of the aerosol generating device 900 or a state of an environment around the aerosol generating device 900, and transmit sensing information obtained through the sensing to the controller 910. Based on the sensing information, the controller 910 may control the aerosol generating device 900 to control operations of the heater 950, restrict smoking, determine whether an aerosol generating article (e.g., a cigarette, a cartridge, etc.) is inserted, display a notification, and perform other functions.

The sensing unit 920 may include at least one of a temperature sensor 922, an insertion detection sensor 924, or a puff sensor 926. However, embodiments are not limited thereto.

The temperature sensor 922 may sense a temperature at which the heater 950 (or an aerosol generating material) is heated. The aerosol generating device 900 may include a separate temperature sensor for sensing the temperature of the heater 950, or the heater 950 itself may perform a function as a temperature sensor. Alternatively, the temperature sensor 922 may be arranged around the battery 940 to monitor the temperature of the battery 940.

The insertion detection sensor 924 may sense whether the aerosol generating article is inserted or removed. The insertion detection sensor 924 may include, for example, at least one of a film sensor, a pressure sensor, a light sensor, a resistive sensor, a capacitive sensor, an inductive sensor, or an infrared sensor, which may sense a signal change by the insertion or removal of the aerosol generating article.

The puff sensor 926 may sense a puff from a user based on various physical changes in an airflow path or airflow channel. For example, the puff sensor 926 may sense the puff of the user based on any one of a temperature change, a flow change, a voltage change, and a pressure change.

The sensing unit 920 may further include at least one of a temperature/humidity sensor, an atmospheric pressure sensor, a magnetic sensor, an acceleration sensor, a gyroscope sensor, a position sensor (e.g., a global positioning system (GPS)), a proximity sensor, or a red, green, blue (RGB) sensor (e.g., an illuminance sensor), in addition to the sensors 922 through 926 described above. In addition, a function of each sensor may be intuitively inferable from its name by one of ordinary skill in the art, and thus, a detailed description thereof will be omitted herein.

The output unit 930 may output information about the state of the aerosol generating device 900 and provide the information to a user. The output unit 930 may include at least one of a display 932, a haptic portion 934, or a sound outputter 936. However, embodiments are not limited thereto. When the display 932 and a touchpad are provided in a layered structure to form a touchscreen, the display 932 may be used as an input device in addition to an output device.

The display 932 may visually provide information about the aerosol generating device 900 to the user. The information about the aerosol generating device 900 may include, for example, a charging/discharging state of the battery 940 of the aerosol generating device 900, a preheating state of the heater 950, an insertion/removal state of the aerosol generating article, a limited usage state (e.g., an abnormal article detected) of the aerosol generating device 900, or the like, and the display 932 may externally output the information. The display 932 may be, for example, a liquid-crystal display (LCD) panel, an organic light-emitting display (OLED) panel, or the like. The display 932 may also be in the form of a light-emitting diode (LED) device.

The haptic portion 934 may provide information about the aerosol generating device 900 to the user in a haptic way by converting an electrical signal into a mechanical stimulus or an electrical stimulus. The haptic portion 934 may include, for example, a motor, a piezoelectric element, or an electrical stimulation device.

The sound outputter 936 may provide information about the aerosol generating device 900 to the user in an auditory way. For example, the sound outputter 936 may convert an electric signal into a sound signal and externally output the sound signal.

The battery 940 may supply power to be used to operate the aerosol generating device 900. The battery 940 may supply power to heat the heater 950. In addition, the battery 940 may supply power required for operations of the other components (e.g., the sensing unit 920, the output unit 930, the user input unit 960, the memory 970, and the communication unit 980) included in the aerosol generating device 900. The battery 940 may be a rechargeable battery or a disposable battery. The battery 940 may be, for example, a lithium polymer (LiPoly) battery, but is not limited thereto.

The heater 950 may receive power from the battery 940 to heat the aerosol generating material. Although not shown in FIG. 6, the aerosol generating device 900 may further include a power conversion circuit (e.g., a direct current (DC)-to-DC (DC/DC) converter) that converts power of the battery 940 and supplies the power to the heater 950. In addition, when the aerosol generating device 900 generates an aerosol in an induction heating manner, the aerosol generating device 900 may further include a DC-to-alternating current (AC) (DC/AC) converter that converts DC power of the battery 940 into AC power.

The controller 910, the sensing unit 920, the output unit 930, the user input unit 960, the memory 970, and the communication unit 980 may receive power from the battery 940 to perform functions. Although not shown in FIG. 6, the aerosol generating device 900 may further include a power conversion circuit, for example, a low dropout (LDO) circuit or a voltage regulator circuit, which converts power of the battery 940 and supplies the power to respective components.

In an embodiment, the heater 950 may be formed of a predetermined electrically resistive material that is suitable. For example, the electrically resistive material may be a metal or a metal alloy including, for example, titanium, zirconium, tantalum, platinum, nickel, cobalt, chromium, hafnium, niobium, molybdenum, tungsten, tin, gallium, manganese, iron, copper, stainless steel, nichrome, or the like. However, embodiments are not limited thereto. In addition, the heater 950 may be implemented as a metal heating wire, a metal heating plate on which an electrically conductive track is arranged, a ceramic heating element, or the like. However, embodiments are not limited thereto.

In another embodiment, the heater 950 may be an induction heater. For example, the heater 950 may include a susceptor that heats an aerosol generating material by generating heat through a magnetic field applied by a coil.

In an embodiment, the heater 950 may include a plurality of heaters. For example, the heater 950 may include a first heater for heating a cigarette, and a second heater for heating a liquid.

The user input unit 960 may receive information input from a user or may output information to the user. For example, the user input unit 960 may include a key pad, a dome switch, a touchpad (e.g., a contact capacitive type, a pressure resistive film type, an infrared sensing type, a surface ultrasonic conduction type, an integral tension measurement type, a piezo effect method, etc.), a jog wheel, a jog switch, or the like, but is not limited thereto In addition, although not shown in FIG. 6, the aerosol generating device 900 may further include a connection interface such as a universal serial bus (USB) interface, and may be connected to another external device through the connection interface such as a USB interface to transmit and receive information or to charge the battery 940.

The memory 970, which is hardware for storing various pieces of data processed in the aerosol generating device 900, may store data processed by the controller 910 and data to be processed thereby. The memory 970 may include at least one type of storage medium of a flash memory type memory, a hard disk type memory, a multimedia card micro type memory, a card type memory (e.g., an SD or XE memory), a random access memory (RAM), a static random access memory (SRAM), a read-only memory (ROM), an electrically erasable programmable read-only memory (EEPROM), a programmable read-only memory (PROM), a magnetic memory, a magnetic disk, or an optical disk. The memory 970 may store an operating time of the aerosol generating device 900, a maximum number of puffs, a current number of puffs, at least one temperature profile, data associated with a smoking pattern of a user, or the like.

The communication unit 980 may include at least one component to communicate with another electronic device. For example, the communication unit 980 may include a short-range wireless communication unit 982 and a wireless communication unit 984.

The short-range wireless communication unit 982 may include a Bluetooth communication unit, a Bluetooth low energy (BLE) communication unit, a near field communication unit, a WLAN (Wi-Fi) communication unit, a ZigBee communication unit, an infrared data association (IrDA) communication unit, a Wi-Fi direct (WFD) communication unit, an ultra-wideband (UWB) communication unit, and an Ant+ communication unit. However, embodiments are not limited thereto.

The wireless communication unit 984 may include, for example, a cellular network communicator, an Internet communicator, a computer network (e.g., a local area network (LAN) or a wide-area network (WAN)) communicator, or the like. However, embodiments are not limited thereto. The wireless communication unit 984 may use subscriber information (e.g., international mobile subscriber identity (IMSI)) to identify and authenticate the aerosol generating device 900 in a communication network.

The controller 910 may control the overall operation of the aerosol generating device 900. In an embodiment, the controller 910 may include at least one processor. The processor may be implemented as an array of a plurality of logic gates, or may be implemented as a combination of a general-purpose microprocessor and a memory in which a program executable by the microprocessor is stored. In addition, it is to be understood by one of ordinary skill in the art to which the present disclosure pertains that it may be implemented in other types of hardware.

The controller 910 may control the temperature of the heater 950 by controlling the supply of power from the battery 940 to the heater 950. For example, the controller 910 may control the supply of power by controlling switching of a switch element between the battery 940 and the heater 950. In another example, a direct heating circuit may control the supply of power to the heater 950 according to a control command from the controller 910.

The controller 910 may analyze a sensing result obtained by the sensing of the sensing unit 920 and control processes to be performed thereafter. For example, the controller 910 may control power to be supplied to the heater 950 to start or end an operation of the heater 950 based on the sensing result obtained by the sensing unit 920. In another example, the controller 910 may control an amount of power to be supplied to the heater 950 and a time for which the power is to be supplied, such that the heater 950 may be heated up to a predetermined temperature or maintained at a desired temperature, based on the sensing result obtained by the sensing unit 920.

The controller 910 may control the output unit 930 based on the sensing result obtained by the sensing unit 920. For example, when a number of puffs counted through the puff sensor 926 reaches a preset number, the controller 910 may inform the user that the aerosol generating device 900 is to be ended soon, through at least one of the display 932, the haptic portion 934, or the sound outputter 936.

According to an embodiment, the controller 910 may control a power supply time and/or a power supply amount for the heater 950 according to a state of the aerosol generating article sensed by the sensing unit 920. For example, when the aerosol generating article is in an over-humidified state, the controller 910 may control the power supply time for an inductive coil to increase a preheating time, compared to a case where the aerosol generating article is in a general state.

One embodiment may also be implemented in the form of a recording medium including instructions executable by a computer, such as a program module executable by the computer. A computer-readable medium may be any available medium that can be accessed by a computer and includes all of a volatile medium, a non-volatile medium, a removable medium, and a non-removable medium. In addition, the computer-readable medium may include both a computer storage medium and a communication medium. The computer storage medium includes all of a volatile medium, a non-volatile medium, a removable medium, and a non-removable medium implemented by any method or technology for storage of information such as computer-readable instructions, data structures, program modules or other data. The communication medium typically includes computer-readable instructions, data structures, other data in modulated data signals such as program modules, or other transmission mechanisms, and includes any information transfer medium.

FIG. 7a is a cross-sectional view of the aerosol generating device 70 according to an embodiment.

Referring to FIG. 7a, the aerosol generating device 70 may include a battery 71, a controller 72, an aerosol forming substrate accommodation portion 73, a light source 74, a reflective plate 75, and a mouthpiece 76.

In an embodiment, the battery 71 may transfer power to the controller 72 and the light source 74.

For example, the controller 72 may control power supplied by the battery 71 to the light source 74. According to an embodiment, the controller 72 may irradiate the aerosol forming substrate accommodation portion 73 by supplying power from the battery 71 to the light source 74.

In an embodiment, the aerosol forming substrate accommodation portion 73 may be disposed on a downstream side of the aerosol generating device 70 adjacent to the mouthpiece 76 to accommodate an aerosol forming substrate. The aerosol forming substrate may include, for example, glycerin, propylene glycol, ethylene glycol, dipropylene glycol, diethylene glycol, triethylene glycol, tetraethylene glycol, or oleyl alcohol, but is not limited thereto. In the art to which the present disclosure pertains, the aerosol forming substrate may be used interchangeably with terms such as a moisturizer or a humectant.

In an embodiment, the light source 74 may be disposed on an upstream side of the aerosol generating device 70, further away from the mouthpiece 76 in comparison to the aerosol forming substrate accommodation portion 73. The light source 74 may be disposed to irradiate light to the aerosol forming substrate accommodation portion 73.

In an embodiment, the light source 74 may include a plurality of light sources 74 arranged to irradiate light toward the aerosol forming substrate accommodation portion 73. In an embodiment, the light source 74 may be an LED, a laser, a fluorescent lamp, a halogen lamp, or an incandescent light bulb, but is not limited thereto. The light source 74 may be implemented using any objects or tools that emit light.

In an embodiment, the reflective plate 75 may be disposed in a space between the aerosol forming substrate accommodation portion 73 and the light source 74. For example, the reflective plate 75 may surround the space between the aerosol forming substrate accommodation portion 73 and the light source 74. The reflective plate 75 may allow light emitted from the light source 74 to reach the aerosol forming substrate accommodation portion 73 instead of leaking to the outside.

In an embodiment, heat may be generated by a surface plasmon resonance phenomenon due to the light irradiated from the light source 74 to a surface of the aerosol forming substrate accommodation portion 73, and may heat the aerosol forming substrate of the aerosol forming substrate accommodation portion 73.

FIG. 7b is an enlarged cross-sectional view of the aerosol forming substrate accommodation portion 73 according to an embodiment.

Referring to FIG. 7b, the aerosol forming substrate accommodation portion 73 may include a plate including a plurality of recesses 732. In an embodiment, the recesses 732 may be formed to a uniform depth and/or different depths in the plate, and may accommodate an aerosol forming substrate. In an embodiment, the aerosol forming substrate may be applied to the entire surface of the aerosol forming substrate accommodation portion 73, and the aerosol forming substrate may be accommodated in the plurality of recesses 732 formed on the surface of the aerosol forming substrate accommodation portion 73. Thus, an amount of the aerosol forming substrate accommodated in the substrate accommodation portion 73 may increase.

In an embodiment, the aerosol forming substrate accommodation portion 73 may include a plate formed of an anodic aluminum oxide (AAO). In an embodiment, the plate formed of anodic aluminum oxide may include the plurality of recesses 732. The anodic aluminum oxide may be an aluminum substrate obtained by chemically coating a surface of aluminum with an aluminum oxide film to prevent oxidation of aluminum. Due to an anodic oxidation treatment on the surface of aluminum, nanometer-sized holes may be arranged at regular intervals on a surface of the plate. In an embodiment, the plurality of recesses 732 in the plate formed of the anodic aluminum oxide may be nanometer-sized holes. In other words, the aerosol forming substrate may be accommodated in the nanometer-sized holes of the plate formed of the anodic aluminum oxide.

In an embodiment, the aerosol forming substrate accommodation portion 73, desirably the plate including the plurality of recesses 732, and more desirably the plate formed of anodic aluminum oxide may be replaceable. In an embodiment, an amount of an aerosol forming substrate accommodated by a single aerosol forming substrate accommodation portion 73 may be limited. Therefore, when the aerosol forming substrate accommodation portion 73 is detachable from and/or attachable to the aerosol generating device 70, a user may periodically replace the aerosol forming substrate accommodation portion 73, desirably only the plate. Thus, the aerosol generating device 70 may be semi-permanently used.

Referring back to FIG. 7b, metal nanoparticles MNP may be applied onto or used to coat the surface of the aerosol forming substrate accommodation portion 73, desirably the surface of the plate including the plurality of recesses 732.

In an embodiment, the metal nanoparticles MNP may include at least one of gold, silver, platinum, copper, palladium, aluminum, chromium, titanium, or rhodium. A plurality of metal nanoparticles MNP may include at least one metal in the form of an element. The plurality of metal nanoparticles MNP may include at least one metal in a metal compound. Desirably, the metal nanoparticles MNP may be gold or platinum. A metal with a relatively low reactivity may have desirable properties as a metal nanoparticle MNP.

In an example, the plurality of metal nanoparticles MNP may include a single type of metals. In another example, the plurality of metal nanoparticles MNP may include a mixture of different metals.

Referring to FIG. 7b, the metal nanoparticles MNP may be applied to a predetermined thickness T on the surface of the aerosol forming substrate accommodation portion 73. In an embodiment, the thickness T of the metal nanoparticles MNP applied to the surface of the aerosol forming substrate accommodation portion 73 may desirably be 10 nm or less. It has been experimentally proven that the surface plasmon resonance phenomenon occurs more actively as the thickness T of the metal nanoparticles MNP applied to the surface decreases. Here, the thickness T of the metal nanoparticles MNP may desirably be 10 nm or less.

FIGS. 7c and 7d are diagrams illustrating examples of a pattern in which the metal nanoparticles MNP are applied to the aerosol forming substrate accommodation portion 73 according to an embodiment.

In an embodiment, a collective oscillation of electrons may occur within the metal nanoparticles MNP according to a wavelength of irradiated light. Here, a period of an oscillation may change according to a shape of a metal nanoparticle MNP, the surrounding environment, a particle spacing, and the like. To maximize an efficiency of heat generated by an oscillation of the metal nanoparticles MNP, the metal nanoparticles MNP may be applied onto the surface of the aerosol forming substrate accommodation portion 73 by forming a predetermined pattern.

Referring to FIGS. 7c and 7d, the surface of the aerosol forming substrate accommodation portion 73 may include a coated region 720a to which the metal nanoparticles MNP are applied, and an uncoated region 720b to which the metal nanoparticles MNP are not applied. As shown in FIGS. 7c and 7d, the uncoated region 720b may be a region in which openings having circular, rhombic, or various polygonal shapes are regularly arranged in a horizontal direction and a vertical direction, and the coated region 720a may be a region other than the uncoated region 720b.

In an embodiment, a pattern of the metal nanoparticles MNP may be formed by a coated region (e.g., a coated region 710a of FIG. 7c, and the coated region 720a of FIG. 7d) to which the metal nanoparticles MNP are applied, and an uncoated region (e.g., an uncoated region 710b of FIG. 7c, and the uncoated region 720b of FIG. 7d) to which the metal nanoparticles MNP are not applied. In an embodiment, a width of the coated region may decrease from a central portion of the coated region toward an edge portion of the coated region, and the coated region may be connected to another coated region at a junction C where the coated region has a smallest width. In an embodiment, for example, the coated region 720a and the uncoated region 720b may form a prismatic pattern. When light is irradiated to the metal nanoparticles MNP of the prismatic pattern, electrons may be accumulated in an edge portion of the coated region 720a of the prismatic pattern to generate a strong oscillation. A portion of such strong oscillation energy of the electrons may be converted into thermal energy, which may cause generation of heat. The coated region 720a and the uncoated region 720b shown in FIGS. 7c and 7d are merely examples, and the metal nanoparticles MNP may be applied onto the surface of the aerosol forming substrate accommodation portion 73 with diverse patterns.

Hereinafter, various embodiments of an aerosol generating device (e.g., the aerosol generating device 70 of FIG. 7a) including a battery (e.g., the battery 71 of FIG. 7a), a controller (e.g., the controller 72 of FIG. 7a), an aerosol forming substrate accommodation portion (e.g., the aerosol forming substrate accommodation portion 73 of FIG. 7a), and a light source (e.g., the light source 74 of FIG. 7a) will be described in detail.

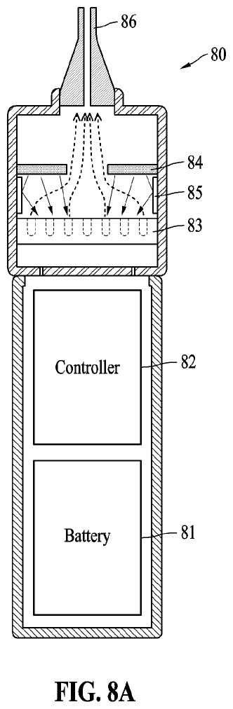

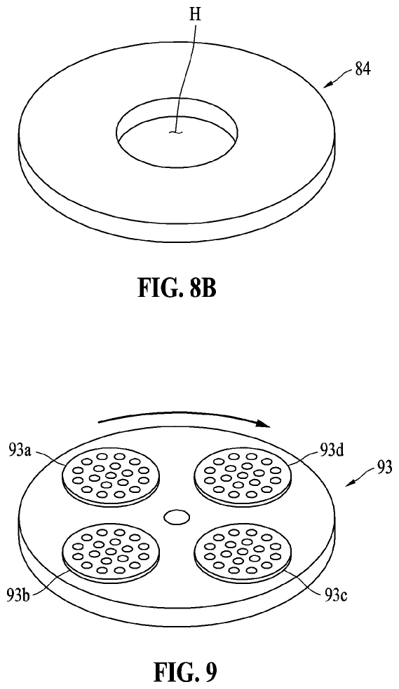

FIG. 8a is a cross-sectional view of an aerosol generating device 80 according to an embodiment.

Referring to FIG. 8a, the aerosol generating device 80 may include a battery 81, a controller 82, an aerosol forming substrate accommodation portion 83, a light source 84, a reflective plate 85, and a mouthpiece 86.

Structures and functions of the aerosol generating device 80 and the above components 81 to 86 included in the aerosol generating device 80 may be the same as and/or similar to structures and functions of the above-described aerosol generating device 70 and the components 71 to 76 included in the aerosol generating device 70. Hereinafter, a difference between the aerosol generating devices 80 and 70 will be described, and descriptions other than the difference may be regarded to be the same as and/or similar to that of the aerosol generating device 70.

Referring to FIG. 8a, the aerosol forming substrate accommodation portion 83, desirably a plate including a plurality of recesses (e.g., the recesses 732 of FIG. 7b), and more desirably a plate formed of an anodic aluminum oxide may be disposed on an upstream side of the aerosol generating device 80 away from the mouthpiece 86. The light source 84 may be disposed on a downstream side of the aerosol generating device 80 relatively adjacent to the mouthpiece 86. In an embodiment, the light source 84 may be disposed to irradiate light to the aerosol forming substrate accommodation portion 83. Based on an arrangement of the aerosol forming substrate accommodation portion 83 and the light source 84 according to an embodiment, the light source 84 may have a shape that allows an aerosol generated in the aerosol forming substrate accommodation portion 83 to be migrated to the mouthpiece 86. For example, the aerosol generating device 80 may include a path to allow an aerosol generated in the aerosol forming substrate accommodation portion 83, desirably a plate including a plurality of recesses (e.g., the recesses 732 of FIG. 7b), to reach the mouthpiece 86.

FIG. 8b is a diagram illustrating a shape of the light source 84 according to an embodiment.

Referring to FIG. 8b, in an example, the light source 84 may have a shape of a plate, desirably a shape of a circular plate. In another example, the light source 84 may have a shape convex toward the mouthpiece 86. The light source 84 having the shape convex toward the mouthpiece 86 may allow the aerosol generated in the aerosol forming substrate accommodation portion 83 to be more smoothly transferred to the mouthpiece 86. The light source 84 may include a hole H penetrating the plate. When the aerosol generating device 80 includes the light source 84 having a shape of the plate including the hole H, the aerosol generated in the aerosol forming substrate accommodation portion 83 disposed on the upstream side of the aerosol generating device 80 may reach the mouthpiece 86 through the hole H of the light source 84. FIG. 8b illustrates merely an example of various shapes of the light source 84 including the path that allows the aerosol generated in the aerosol forming substrate accommodation portion 83 to reach the mouthpiece 86. It is to be understood by one of ordinary skill in the art to which the present disclosure pertains that some of the components shown in FIG. 8b may be omitted or changed or new components may be added.

FIG. 9 is a diagram illustrating a rotation plate 93 according to an embodiment.

Referring to FIG. 9, an aerosol generating device (e.g., the aerosol generating device 70 of FIG. 7a, and/or the aerosol generating device 80 of FIG. 8a) according to an embodiment may include the rotation plate 93. In an embodiment, the rotation plate 93 may include at least one aerosol forming substrate accommodation portion (e.g., the aerosol forming substrate accommodation portion 73 of FIG. 7a), and desirably include a plate including a plurality of recesses (e.g., the recesses 732 of FIG. 7b). A plurality of aerosol forming substrate accommodation portions (e.g., the aerosol forming substrate accommodation portion 73 of FIG. 7a), desirably plates 93a to 93d, each including a plurality of recesses (e.g., the recesses 732 of FIG. 7b), may be regularly arranged on at least one surface of the rotation plate 93. In an embodiment, the rotation plate 93 may rotate about a central axis of the rotation plate 93. A light source (e.g., the light source 74 of FIG. 7a and/or the light source 84 of FIG. 8a) according to an embodiment may irradiate light to at least one of the plurality of plates 93a to 93d disposed on the rotation plate 93. In an embodiment, the aerosol generating device (e.g., the aerosol generating device 70 of FIG. 7a, and/or the aerosol generating device 80 of FIG. 8a) may recognize the number of times a user puffs. When an aerosol forming substrate included in one of the plates 93a to 93d is exhausted, the rotation plate 93 may be rotated by a predetermined angle so that a fixed light source (e.g., the light source 74 of FIG. 7a and/or the light source 84 in FIG. 8a) may irradiate light to another plate. When the aerosol generating device (e.g., the aerosol generating device 70 of FIG. 7a, and/or the aerosol generating device 80 of FIG. 8a) according to an embodiment is used, a replacement frequency of the rotation plate 93 may increase in comparison to an aerosol generating device including a single plate, which may lead to an increase in usability of a user using the aerosol generating device according to an embodiment.

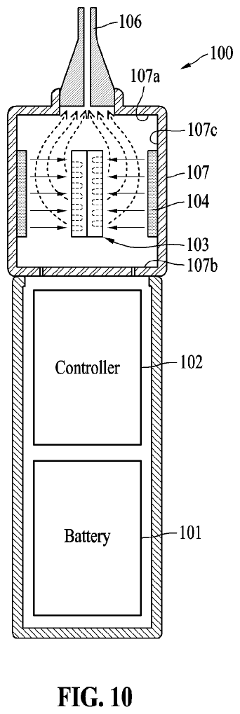

FIG. 10 is a cross-sectional view of an aerosol generating device 100 according to an embodiment.

Referring to FIG. 10, the aerosol generating device 100 may include a battery 101, a controller 102, an aerosol forming substrate accommodation portion 103, a light source 104, a mouthpiece 106, and a housing 107. The housing 107 may include a first end surface 107a that extends in parallel to the mouthpiece 106, a second end surface 107b facing the first end surface 107a, and an inner side surface 107c that connects the first end surface 107a and the second end surface 107b.

Structures and functions of the aerosol generating device 100 and the above components 101 to 106 included in the aerosol generating device 100 may be the same as and/or similar to structures and functions of the above-described aerosol generating device 70 and the components 71 to 76 included in the aerosol generating device 70. Hereinafter, a difference between the aerosol generating devices 100 and 70 will be described, and descriptions other than the difference may be regarded to be the same as and/or similar to that of the aerosol generating device 70.

Referring to FIG. 10, the light source 104 may be disposed on the inner side surface 107c of the housing 107. The light source 104 may irradiate light toward the inside of the housing 107. According to an embodiment, the aerosol forming substrate accommodation portion 103, desirably a plate including a plurality of recesses (e.g., the recesses 732 of FIG. 7b), and more desirably a plate formed of an anodic aluminum oxide, may be disposed to face the light source 104. Desirably, a surface of the plate on which the plurality of recesses (e.g., the recess 732 of FIG. 7b) are arranged may face the light source 104. By an arrangement of the aerosol forming substrate accommodation portion 103 and the light source 104, an aerosol may be generated in the aerosol forming substrate accommodation portion 103 disposed in a central portion of the aerosol generating device 100 and may be transferred directly to the mouthpiece 106. Thus, a user of the aerosol generating device 100 may inhale the aerosol with an enhanced taste of tobacco smoke.

In an embodiment, when the aerosol generating device 70, 80, and/or 100 including the light source 73, 83, and/or 103 and the aerosol forming substrate accommodation portion 74, 84, and/or 104 based on surface plasmon resonance is used, power consumption may be reduced in comparison to an existing aerosol generating device operating by resistive heating. In an embodiment, the light source 73, 83, and/or 103 and the aerosol forming substrate accommodation portion 74, 84, and/or 104 arranged to generate heat by the surface plasmon resonance may provide more homogenous heating of the aerosol forming substrate, in comparison to resistive and inductive heating systems. For example, free electrons of metal nanoparticles MNP may be excited to the same extent regardless of an angle of incidence of incident light.

In an embodiment, the light source 73, 83 and/or 103 and the aerosol forming substrate accommodation portion 74, 84 and/or 104 arranged to generate heat by the surface plasmon resonance may provide more localized heating, in comparison to resistive and inductive heating systems. Advantageously, the localized heating may facilitate heating of individual portions of the aerosol forming substrate or may heat a plurality of discrete aerosol forming substrates. Advantageously, the localized heating may increase an efficiency of the aerosol generating device 70, 80, and/or 100 by increasing or maximizing a number of times heat generated by the heater 13 is transferred to the aerosol forming substrate. In an embodiment, the localized heating may reduce or eliminate unnecessary heating of other components of the aerosol generating device 1.

While the embodiments are described with reference to drawings, it will be apparent to one of ordinary skill in the art that various alterations and modifications in form and details may be made in these embodiments without departing from the spirit and scope of the claims and their equivalents. For example, suitable results may be achieved if the described techniques are performed in a different order, and/or if components in a described system, architecture, device, or circuit are combined in a different manner, and/or replaced or supplemented by other components or their equivalents.

Therefore, other implementations, other embodiments, and/or equivalents of the claims are within the scope of the following claims.

What is claimed is:

1. An aerosol generating device, comprising:
an aerosol forming substrate accommodation portion comprising an aerosol forming substrate and configured to generate heat by a surface plasmon resonance; and
a light source configured to irradiate light toward the aerosol forming substrate accommodation portion,
wherein the light irradiated by the light source causes the surface plasmon resonance.

2. The aerosol generating device of claim 1, wherein the aerosol forming substrate accommodation portion comprises a plate comprising a plurality of recesses configured to accommodate the aerosol forming substrate.

3. The aerosol generating device of claim 1, wherein the aerosol forming substrate accommodation portion comprises an anodic aluminum oxide (AAO).

4. The aerosol generating device of claim 1, wherein metal nanoparticles are applied to a surface of the aerosol forming substrate accommodation portion.

5. The aerosol generating device of claim 4, wherein the metal nanoparticles comprise at least one of gold, silver, palladium, platinum, or copper.

6. The aerosol generating device of claim 4, wherein the metal nanoparticles applied to the aerosol forming substrate accommodation portion forms a predetermined pattern on the aerosol forming substrate accommodation portion.

7. The aerosol generating device of claim 6, wherein
the pattern comprises:
a coated region to which the metal nanoparticles are applied; and
an uncoated region to which the metal nanoparticles are not applied, and
a width of the coated region decreases from a central portion of the coated region toward an edge portion of the coated region, and the coated region is connected to another coated region at a junction where the coated region has a smallest width.

8. The aerosol generating device of claim 6, wherein the metal nanoparticles are applied to have a thickness of 10 nanometers (nm) or less.

9. The aerosol generating device of claim 1, further comprising:
a reflective plate disposed to surround a space between the aerosol forming substrate accommodation portion and the light source.

10. The aerosol generating device of claim 1, wherein the light source comprises at least one of a light-emitting diode (LED), a laser, a fluorescent lamp, a halogen lamp, or an incandescent lamp.

11. The aerosol generating device of claim 2, wherein the plate is replaceable.

12. The aerosol generating device of claim 2, wherein
the plate is disposed between the light source and a mouthpiece of the aerosol generating device.

13. The aerosol generating device of claim 2, wherein
the light source is disposed between the plate and a mouthpiece of the aerosol generating device.

14. The aerosol generating device of claim 13, wherein the light source comprises at least one hole through which the aerosol generated in the plate passes to the mouthpiece.

15. The aerosol generating device of claim 12, further comprising:
a rotation plate; and
a plurality of plates disposed on the rotation plate,
wherein the plurality of plates are disposed around a central axis of the rotation plate.

16. The aerosol generating device of claim 15, wherein the light source is configured to irradiate light to at least one of the plurality of plates disposed on the rotation plate.

17. The aerosol generating device of claim 2, further comprising:
a housing comprising a first end surface, a second end surface opposite to the first end surface, and an inner side surface connecting the first end surface and the second end surface,
wherein the light source is disposed on the inner side surface of the housing and configured to irradiate light toward an inside of the housing, and
wherein the plate is disposed to face the light source.
